(19) United States
(12) Patent Application Publication
(10) Pub. No.: US 2026/0138560 A1
(43) Pub. Date: May 21, 2026

(54) VEHICLE MANAGEMENT SYSTEM, VEHICLE MANAGEMENT METHOD, AND NON-TRANSITORY COMPUTER-READABLE RECORDING MEDIUM

(71) Applicant: TOYOTA JIDOSHA KABUSHIKI KAISHA, Toyota-shi (JP)

(72) Inventors: Tatsuya SUGANO, Seto-shi (JP); Hidenobu KINUGASA, Nagoya-shi (JP); Takahiro YAMAMOTO, Toyota-shi (JP)

(73) Assignee: TOYOTA JIDOSHA KABUSHIKI KAISHA, Toyota-shi (JP)

(21) Appl. No.: 19/352,417

(22) Filed: Oct. 7, 2025

(30) Foreign Application Priority Data
Nov. 15, 2024 (JP) 2024-199568

(51) Int. Cl. B60R 25/04; B60R 25/24; B60W 30/06

(52) U.S. Cl. CPC B60R 25/04; B60R 25/24; B60W 30/06

(57) ABSTRACT

A vehicle management system manages a vehicle in a predetermined area. One or more processors of the vehicle management system are configured to: in response to a handover start request from a user device that stores key information for causing the user device to function as a digital key, start handover processing for transferring operating authority to the vehicle management system; when the handover start request is given, acquire the key information from the user device and store the key information, wherein the key information includes an authentication code for removing a prohibition on a start-up of a travel system of the vehicle by an immobilizer of the vehicle; and when starting up the travel system, transmit to a control device of the vehicle, the authentication code together with a start-up request of the travel system and cause the control device to remove the prohibition on the start-up.

### CROSS-REFERENCES TO RELATED APPLICATION

The present disclosure claims priority under 35 U.S.C. §119 to Japanese Patent Application No. 2024-199568, filed on November 15, 2024, which is incorporated herein by reference in its entirety.

### BACKGROUND

### Technical Field

The present disclosure relates to a technique for controlling a vehicle that operates in accordance with a remote instruction in a predetermined area.

### Background Art

JP 2015-083415 A discloses a vehicle monitoring device that monitors a vehicle in a vehicle parking position. The vehicle monitoring device switches between a vehicle position notification mode and an anti-theft mode in response to a mode switching instruction.

### SUMMARY

When a user entrusts the operating authority of a vehicle to a vehicle management system in a predetermined area (e.g., a parking lot), the user operates a user device to transmit a handover start request to the vehicle management system. The user can then leave the vehicle. On the other hand, the vehicle management system needs to complete predetermined processing, such as processing for identifying (recognizing) the vehicle to be remotely operated, during a period from when the vehicle management system starts handover processing in accordance with the handover start request to when the vehicle management system transmits a start-up request of the vehicle’s travel system to the vehicle. If the execution of the predetermined processing takes time and the user having a key of the vehicle moves away from the vehicle before the start-up request of the travel system is transmitted, the vehicle management system will not be able to cause the vehicle to deactivate an immobilizer, which is necessary to start up the travel system.

The present disclosure has been made in view of the problem described above, and an object thereof is to provide a technique that enables an immobilizer to be deactivated without the need to cause a user to wait near a vehicle when the user entrusts the operating authority of the vehicle to a vehicle management system in a predetermined area.

A vehicle management system according to the present disclosure manages a vehicle in a predetermined area. The vehicle management system includes one or more memory devices and one or more processors. The one or more processors are configured to, in response to a handover start request from a user device that stores key information for causing the user device to function as a digital key of the vehicle, start handover processing for transferring operating authority of the vehicle from a user to the vehicle management system. The one or more processors are also configured to, when the handover start request is given, acquire the key information from the user device and store the key information in the one or more memory devices. The key information includes an authentication code for removing a prohibition on a start-up of a travel system of the vehicle by an immobilizer of the vehicle. The one or more processors are further configured to, when starting up the travel system, transmit to a control device of the vehicle, the authentication code together with a start-up request of the travel system and cause the control device to remove the prohibition on the start-up.

A vehicle management method according to the present disclosure manages a vehicle in a predetermined area. The vehicle management method, which is executed by a computer, includes, in response to a handover start request from a user device that stores key information for causing the user device to function as a digital key of the vehicle, starting handover processing for transferring operating authority of the vehicle from a user to a vehicle management system. The vehicle management method also includes, when the handover start request is given, acquiring the key information from the user device and storing the key information in one or more memory devices of the vehicle management system. The key information includes an authentication code for removing a prohibition on a start-up of a travel system of the vehicle by an immobilizer of the vehicle. The vehicle management method further includes, when starting up the travel system, transmitting to a control device of the vehicle, the authentication code together with a start-up request of the travel system and causing the control device to remove the prohibition on the start-up.

A non-transitory computer-readable recording medium according to the present disclosure stores a vehicle management program executed by a computer for managing a vehicle in a predetermined area. The vehicle management program causes the computer to execute, in response to a handover start request from a user device that stores key information for causing the user device to function as a digital key of the vehicle, starting handover processing for transferring operating authority of the vehicle from a user to a vehicle management system. The vehicle management program also causes the computer to execute, when the handover start request is given, acquiring the key information from the user device and storing the key information in one or more memory devices of the vehicle management system. The key information includes an authentication code for removing a prohibition on a start-up of a travel system of the vehicle by an immobilizer of the vehicle. The vehicle management program further causes the computer to execute, when starting up the travel system, transmitting to a control device of the vehicle, the authentication code together with a start-up request of the travel system and causing the control device to remove the prohibition on the start-up.

According to the present disclosure, when starting up the travel system of the vehicle, the vehicle management system transmits "the authentication code included in the key information acquired from the user device when the handover start request is given" to the control device of the vehicle together with the start-up request of the travel system and causes the control device to remove the prohibition on the start-up of the travel system. This allows the vehicle management system to start up the travel system without the need for the user to wait near the vehicle until the vehicle management system starts up the travel system after the handover processing is completed.

### BRIEF DESCRIPTION OF THE DRAWINGS

FIG. 1 is a conceptual diagram used to describe an overview of a vehicle control system according to an embodiment;

FIG. 2 is a block diagram showing an example of a configuration of a vehicle management system shown in FIG. 1;

FIG. 3 is a block diagram showing an example of a configuration of a vehicle system shown in FIG. 1;

FIG. 4 is a flowchart showing an example of the flow of processing executed by the vehicle management system in relation to "deactivating an immobilizer by borrowing key information from a user device" according to an embodiment;

FIG. 5 is a flowchart showing an example of the flow of processing executed by a control device when the key information is received from the vehicle management system;

FIG. 6 is a flowchart showing another example of the flow of processing executed by the vehicle management system in relation to "deactivating the immobilizer by borrowing the key information from the user device" according to an embodiment;

FIG. 7 is a diagram showing a first example of the acquisition path and storage destination of the key information;

FIG. 8 is a diagram showing a second example of the acquisition path and storage destination of the key information; and

FIG. 9 is a diagram showing a third example of the acquisition path and storage destination of the key information.

### DETAILED DESCRIPTION

Embodiments of the present disclosure will be described with reference to the accompanying drawings.

### 1. Overview of Vehicle Control System

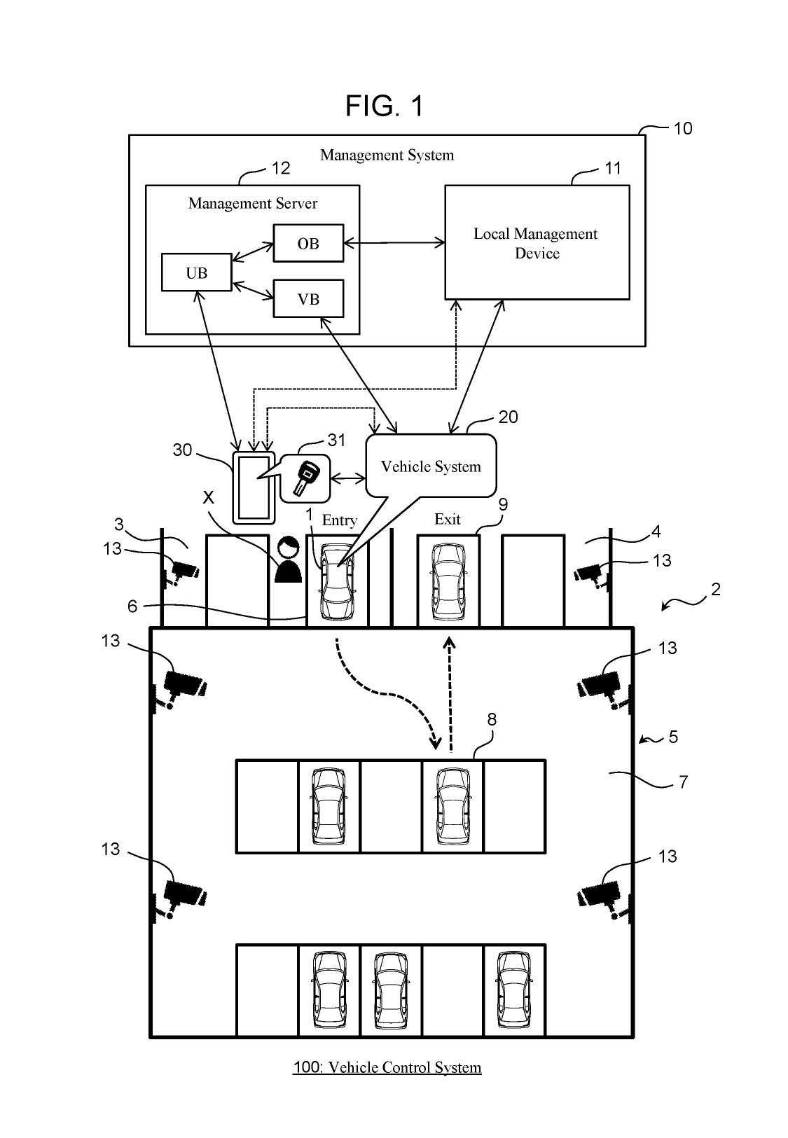

FIG. 1 is a conceptual diagram used to describe an overview of a vehicle control system 100 according to the present embodiment. The vehicle control system 100 controls a vehicle 1. The vehicle 1 is configured to operate in a predetermined area in accordance with a remote instruction INS. The predetermined area is, for example, an area in which the vehicle 1 is able to travel automatically, and the vehicle 1 travels automatically in the predetermined area in accordance with the remote instruction INS. The vehicle control system 100 includes a vehicle management system 10 (hereinafter, also simply referred to as the management system 10 ) and a vehicle system 20 mounted on the vehicle 1. The management system 10 manages the vehicle 1 in the predetermined area. The management of the vehicle 1 by the management system 10 includes generating a remote instruction INS. More specifically, the management system 10 manages automated driving (unmanned driving) of the vehicle 1 within the predetermined area.

### 1-1. Automated Valet Parking (AVP)

In an example shown in FIG. 1, the predetermined area is a parking lot 2. In this example, the vehicle control system 100 corresponds to an automated valet parking system configured to perform the AVP for the vehicle 1 in the parking lot 2. However, the predetermined area is not limited to the parking lot 2, but may be, for example, a city (for example, a smart city) or a part thereof. The following description will be given taking the parking lot 2 as an example of the predetermined area.

The vehicle 1 is configured to be able to execute the AVP in the parking lot 2. The vehicle 1 can travel automatically at least within the parking lot 2 without any driving operation by a user. More specifically, for example, the automated driving of the vehicle 1 within the parking lot 2 is controlled by the management system 10 that utilizes an infrastructure sensor 13. Alternatively, the automated driving may be controlled, for example, by cooperation between the management system 10 and the vehicle system 20. It should be noted that the vehicle 1 may be an automated driving vehicle that is capable of traveling automatically even outside the parking lot 2.

The parking lot 2 includes a drop-off area 3, a pick-up area 4, and a parking area 5. The vehicle 1 that enters the parking lot 2 stops at a stopping position (i.e., drop-off space) 6 provided in the drop-off area 3. At the drop-off area 3, the user gets off the vehicle 1. On the other hand, the vehicle 1 that leaves the parking lot 2 stops at the pick-up area 4. At the pick-up area 4, the user gets on the vehicle 1. The drop-off area 3 can also be called an entry area, and the pick-up area 4 can also be called an exit area. The drop-off area 3 and the pick-up area 4 may be provided separately as shown in FIG. 1 or may be provided as a drop-off/pick-up area without distinction between the drop-off and the pick-up. The parking area 5 includes a passage 7 and a plurality of parking space 8. The passage 7 is an area in which the vehicle 1 travels. The parking space 8 is a space in which the vehicle 1 is parked.

The management system 10 manages the AVP of the vehicle 1 in the parking lot 2. In one example, the management system 10 includes a local management device 11 and a management server 12 on a cloud.

The local management device 11 is installed in each parking lot 2. The local management device 11 executes, for example, the following processing. That is, the local management device 11 uses the infrastructure sensor 13 to grasp the situation of the parking lot 2 (e.g., the position and status of each vehicle 1 in the parking lot 2). The local management device 11 allocates a parking space 8 to the vehicle 1. The local management device 11 generates a remote instruction INS, communicates with the vehicle 1, and transmits the generated remote instruction INS to the vehicle 1.

The management server 12 controls the respective local management devices 11 of a plurality of parking lot 2. The management server 12 may include, for example, three servers OB, VB, and UB. The server OB is installed for each parking lot 2. The server OB manages the parking lot 2 (e.g., reservations of parking spaces 8, entry and exit of the vehicle 1) and the travel control authority of the vehicle 1. Further, the server OB communicates with the corresponding local management device 11 to collect and provide various kinds of information. The server VB manages the remote operating authority of the vehicle 1 (e.g., authority to operate the power supply of the vehicle 1). Further, the server VB communicates with vehicle 1, collects various kinds of vehicle management information (e.g., information indicating the status of the vehicle 1, identification information for the vehicle 1 (vehicle ID)), and provides various kinds of information (e.g., progress status of AVP). The server UB manages users of automated valet parking service (AVP service) (including user authentication) and manages reservations for the AVP service made by users. The server UB communicates with a user device 30 operated by a user of the AVP service. The user device 30 is, for example, a terminal device (e.g., a smartphone) of a user. The membership information of the user is registered in advance in the server UB. Further, the server UB communicates with each of servers OB and VB, and transmits and receives various kinds of information to and from each of the servers OB and VB.

An example of a flow when a user X uses the AVP service will be described below.

First, the user X reserves an AVP. For example, the user X operates the user device 30 to input information, such as the ID information of the user X, a desired parking lot 2, a desired date of use, and a desired time of use. The user device 30 transmits reservation information including the input information to the management system 10 (server UB). The management system 10 executes reservation processing based on the reservation information and transmits a reservation completion notification to the user device 30. In addition, the management system 10 transmits the authentication information depending on the reservation information to the user device 30. The user device 30 receives the authentication information and holds the received authentication information.

Entry (check-in) of the vehicle 1 into the parking lot 2 is as follows. As illustrated in FIG. 1 , the vehicle 1 carrying the user X arrives at the drop-off area 3 of the parking lot 2 and stops at the stopping position 6. In the drop-off area 3, the user X (and other occupants, if any) gets off the vehicle 1.

In order to start the automated driving (i.e., automatic traveling) of the vehicle 1 based on the remote instruction INS from the management system 10 in the AVP (hereinafter, simply referred to as "AVP driving"), it is necessary to transfer operating authority of the vehicle 1 from the user X to the management system 10. To transfer the operating authority, the user X operates the user device 30 to transmit a handover start request to the management system 10 (server UB). More specifically, after the vehicle 1 arrives at the drop-off area 3, it is assumed that the user X basically makes a handover start request after getting off the vehicle 1. However, the handover start request may be made by the user X before the user X gets off the vehicle 1. The handover start request is transmitted together with, for example, the authentication information of the user X.

In response to the handover start request transmitted from the user device 30, the management system 10 (server UB) authenticates the user X. When the authentication is completed, the management system 10 (local management device 11 ) starts handover processing (i.e., authority transfer processing) for transferring the operating authority of the vehicle 1 from the user X to the management system 10.

The handover processing includes, for example, processing for establishing wireless communication between the management system 10 and the vehicle 1 (vehicle system 20), and processing for identifying the vehicle 1 as the target vehicle for the current AVP (vehicle identification processing). Identification (authentication) of the target vehicle is necessary to confirm that the vehicle 1 that is about to receive the AVP service is the vehicle 1 (target vehicle) of a genuine user X. In one example, the vehicle identification processing may be performed using a predetermined action of the vehicle 1 (e.g., blinking a light of the vehicle 1). If the vehicle 1 is a genuine target vehicle, the vehicle 1 is expected to perform the predetermined action in accordance with an instruction from the management system 10. After giving the instruction, the management system 10 uses the infrastructure sensor 13 to recognize the action performed by the vehicle 1. Then, when the recognized action matches an expected action, the management system 10 identifies, as the target vehicle, the vehicle 1 that have performed the recognized action.

When the handover processing is completed, the operating authority of the vehicle 1 is transferred from the user X to the management system 10. The management system 10 (local management device 11 ) executes entry processing for the vehicle 1. In the entry processing, the management system 10 communicates with the vehicle 1 and transmits a remote instruction INS (start-up request) requesting the start-up of a travel system 23 of the vehicle 1 (i.e., turning on the power supply of the travel system 23). The vehicle 1 automatically starts up the travel system 23 in accordance with the received remote instruction INS, provided that an immobilizer, which will be described below, can be deactivated. Further, the management system 10 checks the usage status of the parking lot 2, allocates an available parking space 8 to the vehicle 1, and then generates a target route for the vehicle 1 from the drop-off area 3 to the allocated parking space 8. Then, the management system 10 communicates with the vehicle 1 and transmits to the vehicle 1 a remote instruction INS requesting the vehicle 1 to perform the AVP driving along the generated target route toward the parking space 8. The management system 10 also transmits to the vehicle 1 the information about the target route, together with this remote instruction INS.

In accordance with the target route received from the management system 10, the vehicle 1 performs the AVP driving toward the parking space 8 allocated to the vehicle 1 and automatically parks in the allocated parking space 8 (Entry Completed). When the parking of the vehicle 1 is completed, the vehicle 1 notifies the management system 10 of the completion of the parking. Alternatively, the management system 10 may use an infrastructure sensor 13 installed in the parking lot 2 to detect that the parking of the vehicle 1 has been completed. After the parking of the vehicle 1 is completed, the management system 10 (local management device 11 ) communicates with the vehicle 1 and transmits a remote instruction INS requesting to the vehicle 1 to turn off the power supply of the travel system 23. The vehicle 1 automatically turns off the power supply in accordance with the received remote instruction INS. In addition, the management system 10 (server OB) stores, in association with the user X, information about the parking space 8 in which the vehicle 1 is parked. Additionally, the management system 10 (local management device 11) may cause the vehicle 1 to performs the AVP driving in order to move the vehicle 1 to another parking space 8 while the vehicle 1 is parked.

Exit (check-out) of the vehicle 1 from the parking lot 2 is as follows. The user X operates the user device 30 to transmit to the management system 10 (server UB), an exit request for leaving the vehicle 1. The exit request includes the authentication information of the user X. In response to the exit request, the management system 10 (server UB) authenticates the user X. When the authentication is completed, the management system 10 (local management device 11 ) executes exit processing for the vehicle 1.

In the exit processing, the management system 10 communicates with the vehicle 1 and executes a remote instruction INS (start-up request) requesting the vehicle 1 to start up (i.e., power on) the travel system 23 of the vehicle 1. The vehicle 1 automatically starts up the travel system 23 in accordance with the received remote instruction INS, provided that the immobilizer can be deactivated. Further, the management system 10 checks the usage status of the parking lot 2, allocates an available pick-up space 9 in the pick-up area 4 to the vehicle 1, and then generates a target route for the vehicle 1 from the parking space 8 of the vehicle 1 to the allocated pick-up space 9. Then, the management system 10 communicates with the vehicle 1 and transmits to the vehicle 1 a remote instruction INS requesting the vehicle 1 to perform the AVP driving along the generated target route toward the pick-up space 9. The management system 10 also transmits to the vehicle 1 the information about the target route, together with this remote instruction INS.

The vehicle 1 performs the AVP driving toward the allocated pick-up space 9 in accordance with the received target route. When the vehicle 1 arrives at the pick-up area 4 and automatically stops at the pick-up space 9 allocated to the vehicle 1, the vehicle 1 notifies the management system 10 of the arrival of the vehicle 1 at the pick-up area 4. Alternatively, the management system 10 may detect the arrival of the vehicle 1 using an infrastructure sensor 13 installed in the pick-up area 4.

After the vehicle 1 arrives at the pick-up area 4, the user X transmits a handback start request to the management system 10 (server UB) to transfer (return) the operating authority of the vehicle 1 from the management system 10 to the user X himself/herself. In response to the handback start request transmitted from the user device 30, the management system 10 (server UB) authenticates the user X. When the authentication is completed, the management system 10 (local management device 11) starts handback processing. When the handback processing is completed, the user X (and other occupants, if any) gets on the vehicle 1. The vehicle 1 then departs for the next destination and leaves the parking lot 2 (Exit Completed).

### 2. System Configuration Example

As described above, the vehicle control system 100 includes the vehicle management system 10 and the vehicle system 20.

### 2-1. Vehicle Management System

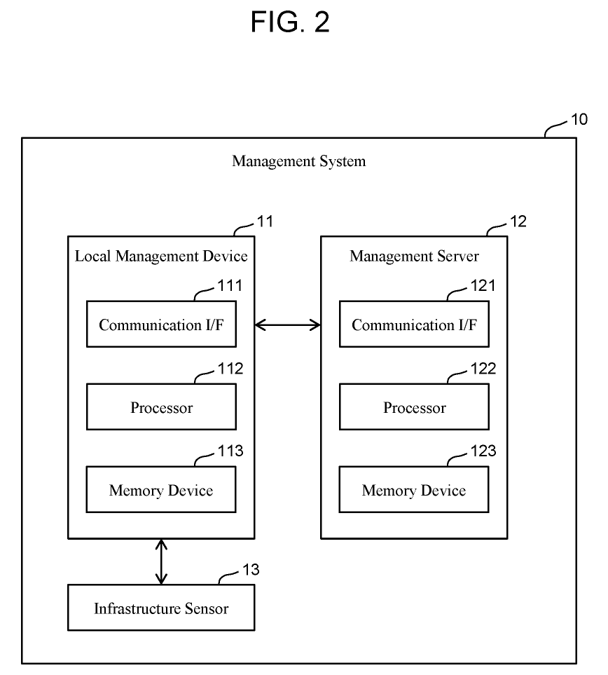

FIG. 2 is a block diagram showing an example of the configuration of the vehicle management system 10 shown in FIG. 1. The management system 10 includes the local management device 11, the management server 12 on a cloud, and one or more infrastructure sensors 13 (hereinafter, simply referred to as an infrastructure sensor 13). The infrastructure sensor 13 is installed at various locations in the parking lot 2 as shown in FIG. 1. The infrastructure sensor 13 includes, for example, one or more infrastructure cameras, and recognizes the situation of the parking lot 2 including the drop-off area 3 and the pick-up area 4. The information acquired by the infrastructure sensor 13 is transmitted to the local management device 11.

The local management device 11 includes a communication interface (communication I/F) 111, one or more processors 112 (hereinafter, simply referred to as a processor 112), and one or more memory devices 113 (hereinafter, simply referred to as a memory device 113). In addition, the one or more processors 112 correspond to an example of "one or more first processors" according to the present disclosure.

The communication I/F 111 communicates with each of the vehicle 1 (vehicle system 20), the management server 12 (server OB), and the infrastructure sensor 13 via a communication network. Further, the communication I/F 111 may communicate directly with the user device 30 (e.g., via Wi-Fi (registered trademark)). Furthermore, the user device 30 functions as a key (i.e., a digital key) 31 for the vehicle 1 as described below. The communication I/F 111 may be configured to be able to communicate with the user device 30 (digital key 31) in accordance with the same communication method as a communication Ckey between the digital key 31 and the vehicle 1, which will be described below.

The processor 112 executes various kinds of processing. Examples of the processor 112 include a general purpose processor, a special purpose processor, a Central Processing Unit (CPU), a Graphics Processing Unit (GPU), an Application Specific Integrated Circuit (ASIC), a Field-Programmable Gate Array (FPGA), an integrated circuit, a conventional circuit, and/or combinations thereof. The processor 112 may also be referred to as circuitry or processing circuitry. The circuitry is hardware that is programmed to execute the recited functions or hardware that executes the functions. The memory device 113 stores various kinds of information. Examples of the memory device 113 include a volatile memory, a non-volatile memory, a hard disk drive (HDD), and a solid state drive (SSD).

The functions of the local management device 11 may be realized by cooperation between the processor 112 that executes a computer program (corresponding to a "vehicle management program" according to the present disclosure) and the memory device 113. The computer program is stored in the memory device 113. Alternatively, the computer program may be recorded in a non-transitory computer-readable recording medium or may be provided via a network.

The management server 12 (more specifically, for example, each of the three servers OB, VB, and UB) includes a communication I/F 121, one or more processors 122 (hereinafter, simply referred to as a processor 122), and one or more memory devices 123 (hereinafter, simply referred to as a memory device 123).

The communication I/F 121 communicates with each of the local management device 11, the vehicle 1 (vehicle system 20), and the user device 30 via a communication network.

An example of the configuration of the processor 122 is the same as that of the processor 112 described above. Moreover, an example of the configuration of the memory device 123 is the same as that of the memory device 113 described above. For example, the memory device 123 of the server OB stores information (e.g., map information about the parking lot 2, entry and exit time information for each vehicle 1 in the parking lot 2) about the predetermined area (e.g., parking lot 2). The memory device 123 of the server VB stores the vehicle management information described above. The memory device 123 of the server UB stores user information (e.g., identification information of each user (user ID), service reservation information). The functions of the management server 12 (e.g., each of servers OB, VB, and UB) may be realized by cooperation between the processor 122 that executes a computer program (corresponding to the "vehicle management program" of the present disclosure) and the memory device 123. The computer program is stored in the memory device 123. Alternatively, the computer program may be recorded in a non-transitory computer-readable recording medium or may be provided via a network.

### 2-2. Vehicle System

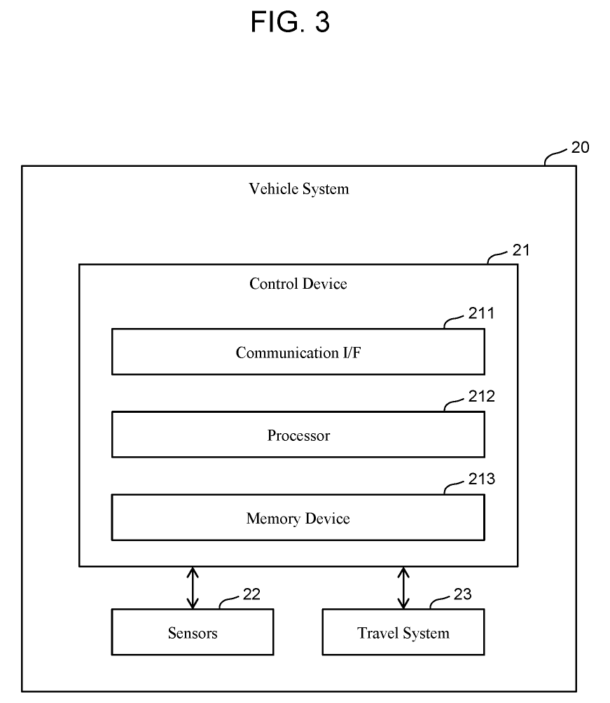

FIG. 3 is a block diagram showing an example of the configuration of the vehicle system 20 shown in FIG. 1. The vehicle system 20 is mounted on the vehicle 1 and includes a control device 21 , sensors 22 , and the travel system 23.

The control device 21 controls the vehicle 1 in accordance with various remote instructions INS. The control device 21 includes a communication I/F 211, one or more processors 212 (hereinafter, simply referred to as a processor 212), and one or more memory devices 213 (hereinafter, simply referred to as a memory device 213).

The communication I/F 211 communicates with the management system 10 (more specifically, with each of the local management device 11 and the management server 12 (server VB)) via a communication network. Further, the communication I/F 211 performs the communication Ckey, which will be described below, with the digital key 31 for the vehicle 1 (more specifically, the user device 30 functioning as the digital key 31). Furthermore, the communication I/F 211 may communicate directly with the user device 30 (e.g., via Wi-Fi).

An example of the configuration of the processor 212 is the same as that of the processor 112 described above. Moreover, an example of the configuration of the memory device 213 is the same as that of the memory device 113 described above. The functions of the control device 21 may be realized by cooperation between the processor 212 that executes a computer program and the memory device 213. The computer program is stored in the memory device 213. Alternatively, the computer program may be recorded in a non-transitory computer-readable recording medium or may be provided via a network.

The vehicle system 20 has a function as the immobilizer for preventing an improper start-up (i.e., activation) of the travel system 23. For example, the control device 21 has this function. Specifically, the user device 30 (e.g., smartphone) carried by the user X stores key information Ikey for causing the user device 30 to function as the digital key 31 for the vehicle 1. The user device 30 is configured to be usable as the digital key 31 by the user X in place of a physical key without the need for the physical key. More specifically, the user device 30 is configured to function as a transponder for the digital key 31. That is, the user device 30 performs the communication Ckey with the vehicle 1 (control device 21) as the transponder. The key information Ikey stored in the user device 30 includes an authentication code AC that is unique to the digital key 31. This authentication code AC is also stored in the memory device 213 of the control device 21. The communication Ckey between the vehicle system 20 (control device 21) and the digital key 31 is short-range wireless communication (e.g., UWB (Ultra Wideband), Bluetooth (registered trademark), NFC (Near Field Communication)).

When the control device 21 receives the authentication code AC from the digital key 31 upon starting up the travel system 23, the control device 21 (processor 212 ) compares the received authentication code AC of the digital key 31 with the authentication code AC stored in the memory device 213. As a result, when these authentication codes AC match, the control device 21 permits the start-up of the travel system 23. In other words, the control device 21 removes (i.e., lifts) the prohibition on starting up the travel system 23 imposed by the immobilizer.

The sensors 22 include a recognition sensor, a vehicle state sensor, and a position sensor, for example. The recognition sensor recognizes (detects) the situation around the vehicle 1. Examples of the recognition sensor include a camera, a LIDAR (Laser Imaging Detection and Ranging), and a radar. The vehicle state sensor detects the state of the vehicle 1. Examples of the vehicle state sensor include a speed sensor, an acceleration sensor, a yaw rate sensor, and a steering angle sensor. The position sensor detects the position and orientation of the vehicle 1. An example of the position sensor is a Global Navigation Satellite System (GNSS) sensor.

The travel system 23 is a system that operates the vehicle 1. The travel system 23 is, for example, an electric drive system, and includes an electric motor for driving the vehicle 1, a battery for supplying power to the electric motor, and a controller. The travel system 23 may include an internal combustion engine in addition to or instead of the electric motor in order to drive the vehicle 1.

### 3. Deactivating Immobilizer by Borrowing Key Information from User Device

When the user X entrusts the authority to operate the vehicle 1 to the management system 10 in a predetermined area (e.g., the parking lot 2), the user X operates the user device 30 as described above to transmit the handover start request to the management system 10. The user X can then leave the vehicle 1. On the other hand, the management system 10 needs to complete predetermined processing, such as the vehicle identification processing, between starting the handover processing in accordance with the handover start request and transmitting to the vehicle 1 the start-up request for the travel system 23 of the vehicle 1. If the execution of the predetermined processing takes time and the user X having the digital key 31 (user device 30) for the vehicle 1 leaves the vehicle 1 before the start-up request for the travel system 23 is transmitted, the management system 10 will not be able to cause the vehicle 1 to verify the authentication code AC with the digital key 31. In other words, the management system 10 will not be able to cause the vehicle 1 to deactivate the immobilizer, which is necessary to start up the travel system 23.

Accordingly, in the present embodiment, when the user X entrusts the operating authority of vehicle 1 to the management system 10 in a predetermined area (e.g., when the vehicle 1 enters a predetermined area, such as the parking lot 2), upon receiving the handover start request from the user device 30, the management system 10 acquires the key information Ikey from the user device 30 as the digital key 31 and stores the key information Ikey in the memory device 123 or 113. In other words, the user device 30 lends the key information Ikey to the management system 10. As described above, the key information Ikey includes the authentication code AC for removing the prohibition on the start-up of the travel system 23 by the immobilizer of the vehicle 1.

Furthermore, when starting up the travel system 23, the management system 10 transmits the authentication code AC to the control device 21 of the vehicle 1 along with the start-up request of the travel system 23 and causes the control device 21 to remove the prohibition on the start-up of the travel system 23 (i.e., deactivate the immobilizer). More specifically, in the present embodiment, the local management device 11 installed in the predetermined area (e.g., parking lot 2), that is, the local management device 11 located near the vehicle 1 executes processing to cause the control device 21 to deactivate the immobilizer.

### 3-1. Processing Flow

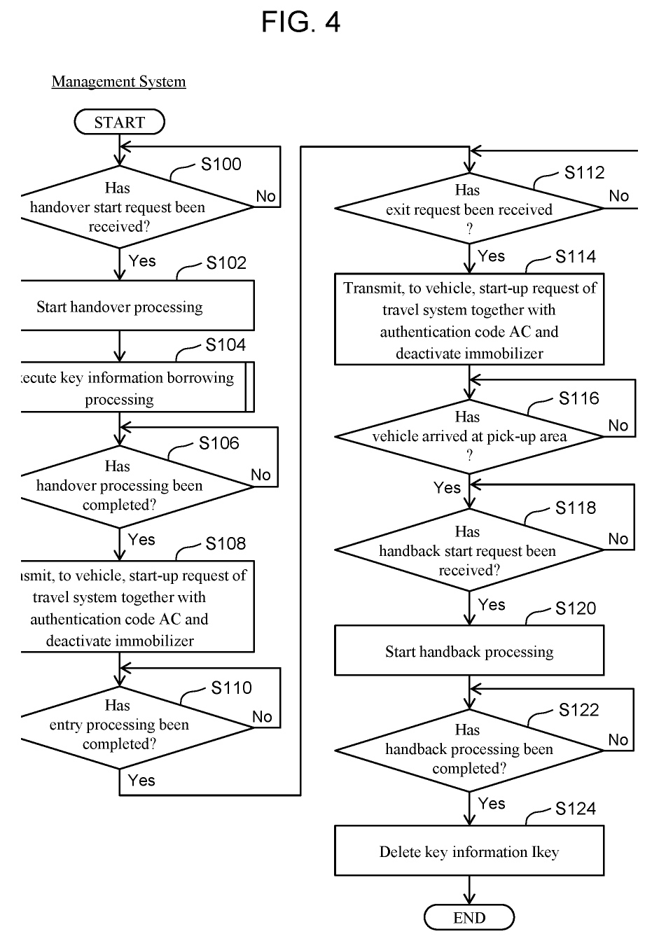

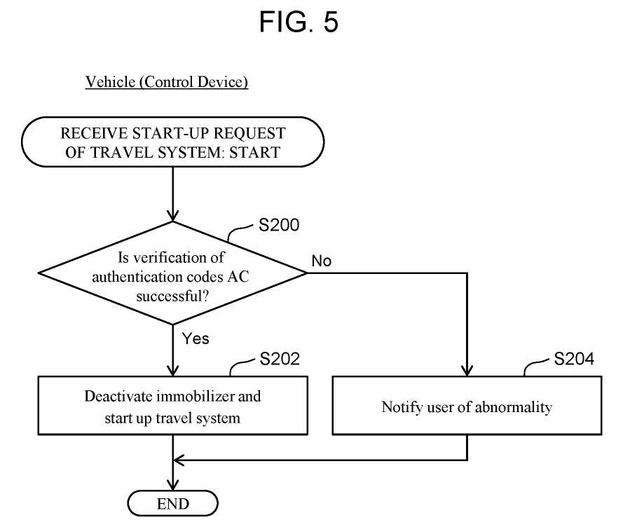

FIG. 4 is a flowchart showing an example of the flow of processing executed by the vehicle management system 10 (mainly, the local management device 11) in relation to "deactivating the immobilizer by borrowing key information Ikey from the user device 30" according to the present embodiment. The processing of this flowchart starts when, for example, the vehicle 1 arrives at the drop-off area 3. Further, FIG. 5 is a flowchart showing an example of the flow of processing executed by the control device 21 when the key information Ikey is received from the vehicle management system 10.

In FIG. 4, in step S100, the local management device 11 communicates with the server UB via the server OB and determines whether or not the handover start request has been received from the user device 30. As a result, when the handover start request is received (step S100; Yes), the processing proceeds to step S102.

In step S102, the local management device 11 starts the handover processing described above. Then, in step S104, in conjunction with the handover start request, the management system 10 executes "key information borrowing processing". The key information borrowing processing is processing for acquiring the key information Ikey including the authentication code AC from the user device 30 (digital key 31 ) and storing the key information Ikey in the memory device 123 or 113. More specifically, for example, the key information Ikey is stored in the memory device 123 or 113 in association with a reservation ID of the AVP included in the above-described service reservation information that the management server 12 (server UB) has. Specific examples of the path through which the key information Ikey is acquired from the user device 30 (digital key 31) by the key information borrowing processing; specific examples of the storage destination of the acquired key information Ikey; and specific examples of the path through which the key information Ikey is acquired when the key information Ikey is used (step S108 or S114 described below) will be described below in Section 3-1-2.

In step S106 subsequent to step S104, the local management device 11 determines whether or not the handover processing has been completed. As a result, when the handover processing has been completed (step S106; Yes), the processing proceeds to step S108. The processing of step S108 is executed when the travel system 23 is started up in the predetermined area (more specifically, when the vehicle 1 starts moving from the drop-off area 3 of the parking lot 2 to the parking space 8 allocated to the vehicle 1).

In step S 108 , the local management device 11 reads (acquires) the authentication code AC from the memory device 123 or 113. The local management device 11 then transmits to the vehicle 1 (control device 21) the start-up request of the travel system 23 together with the read authentication code AC and causes the control device 21 to remove the prohibition on the start-up of the travel system 23 by the immobilizer. That is, the local management device 11 starts the entry processing described above. It should be noted that the processing entity of step S108 is not necessarily limited to the local management device 11 and may be executed by the management server 12 on the cloud. The same applies to step S114 described below.

Additionally, the transmission (notification) of the authentication code AC from the local management device 11 to the vehicle 1 may be performed by using the communication Ckey between the digital key 31 and the control device 21 such that the authentication code AC itself is transmitted. Alternatively, the transmission (notification) of the authentication code AC may be performed by using an AVP communication (i.e., a communication used between the local management device 11 and the vehicle 1 for providing the AVP service). In this AVP communication, the authentication code AC is converted into encrypted information (data) specific to the AVP and then transmitted. In one example of the AVP communication, the local management device 11 communicates directly with the vehicle 1 in accordance with a wireless communication method, such as Wi-Fi. In another example of the AVP communication, the local management device 11 communicates with the vehicle 1 via the management server 12 (more specifically, servers OB and VB) in accordance with a wireless communication method, such as LTE.

After the vehicle 1 receives the start-up request together with the authentication code AC, the control device 21 executes the processing shown in FIG. 5. First, the control device 21 checks the authentication code AC transmitted (notified) from the local management device 11 (management system 10 ) against the authentication code AC stored in the memory device 213 of the control device 21. More specifically, when the authentication code AC itself is transmitted from the local management device 11 using the communication Ckey, the control device 21 verifies the authentication code AC in the same manner as when the authentication code AC is normally transmitted from the digital key 31. Furthermore, when the authentication code AC is transmitted using the AVP communication described above, the control device 21 verifies the authentication code AC based on the encrypted information specific to the AVP.

When the two authentication codes AC match, that is, when the verification of the authentication codes AC is successful (step S200; Yes), the processing proceeds to step S202. In step S202, the control device 21 permits the start-up of the travel system 23. In other words, the control device 21 removes the prohibition on the start-up of the travel system 23 by the immobilizer and starts up the travel system 23. After the travel system 23 starts up, the vehicle 1 performs the AVP driving toward the allocated parking space 8.

On the other hand, when the verification of the authentication codes AC is not successful (step S200; No), the processing proceeds to step S204. In step S204, the control device 21 communicates with the user device 30 via the servers VB and UB (or directly) and notifies the user X of an abnormality. An example of the abnormality is that the AVP driving cannot be performed. For example, if the local management device 11 is configured to receive information from the vehicle 1 indicating that the verification is unsuccessful, the local management device 11 that receives the information may perform the notification described above. Further, the notification may also include a message requesting the user X to return to the vehicle 1 together with the digital key 31 such that the AVP driving can be started. For example, if the user X returns to the vehicle 1 and the control device 21 starts up the travel system 23, the vehicle 1 performs the AVP driving toward the allocated parking space 8.

In FIG. 4, in step S110 subsequent to step S108, the local management device 11 determines whether or not the entry processing has been completed. As a result, when the entry processing is completed (step S110; Yes), the processing proceeds to step S112.

In step S112, the local management device 11 communicates with the server UB via the server OB and determines whether or not the exit request for leaving the parked vehicle 1 has been received from the user device 30. As a result, when the exit request is received (step S112; Yes), the processing proceeds to step S114. The processing of step S114 is executed when the travel system 23 is started up in the predetermined area (more specifically, when the vehicle 1 starts moving from the parking space 8 of the vehicle 1 to the pick-up area 4 of the parking lot 2).

In step S114, similarly to step S108, the local management device 11 transmits the start-up request of the travel system 23 together with the authentication code AC to the vehicle 1 (control device 21) and causes the control device 21 to remove the prohibition on the start-up of the travel system 23 by the immobilizer. That is, the local management device 11 starts the exit processing described above. When the vehicle 1 receives the start-up request together with the authentication code AC in the processing of step S114, the control device 21 also executes the processing shown in FIG. 5 as described above. Thereafter, the vehicle 1 performs the AVP driving toward the pick-up area 4.

In step S116 subsequent to step S114, the local management device 11 determines whether or not the vehicle 1 has arrived at the pick-up area 4 (more specifically, the allocated pick-up space 9). If the vehicle 1 has arrived at the pick-up area 4 (step S116; Yes), the processing proceeds to step S118.

In step S118, the local management device 11 communicates with the server UB via the server OB and determines whether or not the handback start request has been received from the user device 30. As a result, when the handback start request is received (step S118; Yes), the processing proceeds to step S120.

In step S120, the local management device 11 starts the above-described handback processing in response to the received handback start request. The handback processing is included in the exit processing. Then, in step S122, the local management device 11 determines whether the handback processing has been completed. As a result, when the handback processing is completed (step S122; Yes), the processing proceeds to step S124.

In step S124, the management system 10 deletes the key information Ikey. Specifically, for example, when the key information Ikey is stored in the memory device 123 of the management server 12 (e.g., server OB or VB), the local management device 11 transmits an instruction to the server OB or VB to delete the key information Ikey, and the server OB or VB deletes the key information Ikey from the memory device 123 thereof. Alternatively, for example, when the key information Ikey is stored in the memory device 113 of the local management device 11, the local management device 11 deletes the key information Ikey from the memory device 113.

Additionally, upon the completion of the handback processing, the exit processing is completed. Then, when the user X gets into the vehicle 1 and the vehicle 1 leaves the parking lot 2, the exit of the vehicle 1 is completed.

### 3-1-1. Timing of Deleting Key Information

As already described, the management system 10 deletes, from the memory device 123 or 113, the key information Ikey after the key information Ikey has been used to provide the AVP service.

### 3-1-1-1. First Example

In the example of the processing shown in FIG. 4, upon the end of a handover period during which the operating authority of the vehicle 1 is transferred from the user X to the management system 10, i.e., upon completion of the handback processing (step S122; Yes), the management system 10 deletes the key information Ikey from the memory device 123 or 113 (step S124).

### 3-1-1-2. Second Example

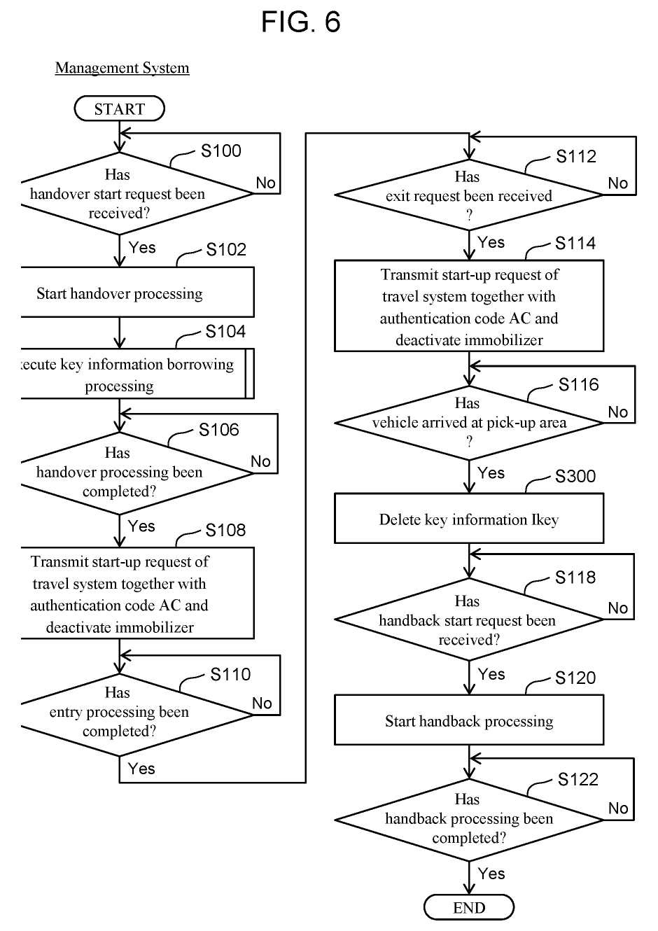

FIG. 6 is a flowchart showing another example of the flow of processing executed by the vehicle management system 10 (mainly the local management device 11) in relation to "deactivating the immobilizer by borrowing the key information Ikey from the user device 30" according to the present embodiment. The processing of this flowchart is different from the processing of the flowchart shown in FIG. 4 in the timing of deleting the key information Ikey when the vehicle 1 leaves the predetermined area.

Specifically, in FIG. 6, when the vehicle 1 arrives at the pick-up area 4 in order to leave the predetermined area (e.g., parking lot 2) (step S116; Yes), the management system 10 deletes the key information Ikey from the memory device 123 or 113 (step S300).

Additionally, instead of the second example shown in FIG. 6, the timing of deleting the key information Ikey when the vehicle 1 leaves the predetermined area may be when the start-up of the travel system 23 for moving the vehicle 1 from the parking space 8 to the pick-up space 9 for the exit from the predetermined area is completed.

### 3-1-2. Acquisition Path and Storage Destination of Key Information

Specific examples of the path through which the key information Ikey is acquired from the user device 30 (digital key 31) by the key information borrowing processing (see step S104); specific examples of the storage destination of the acquired key information Ikey; and specific examples of the path through which the key information Ikey is acquired when the key information Ikey is used (step S108 or S114) will be described here.

### 3-1-2-1. First Example

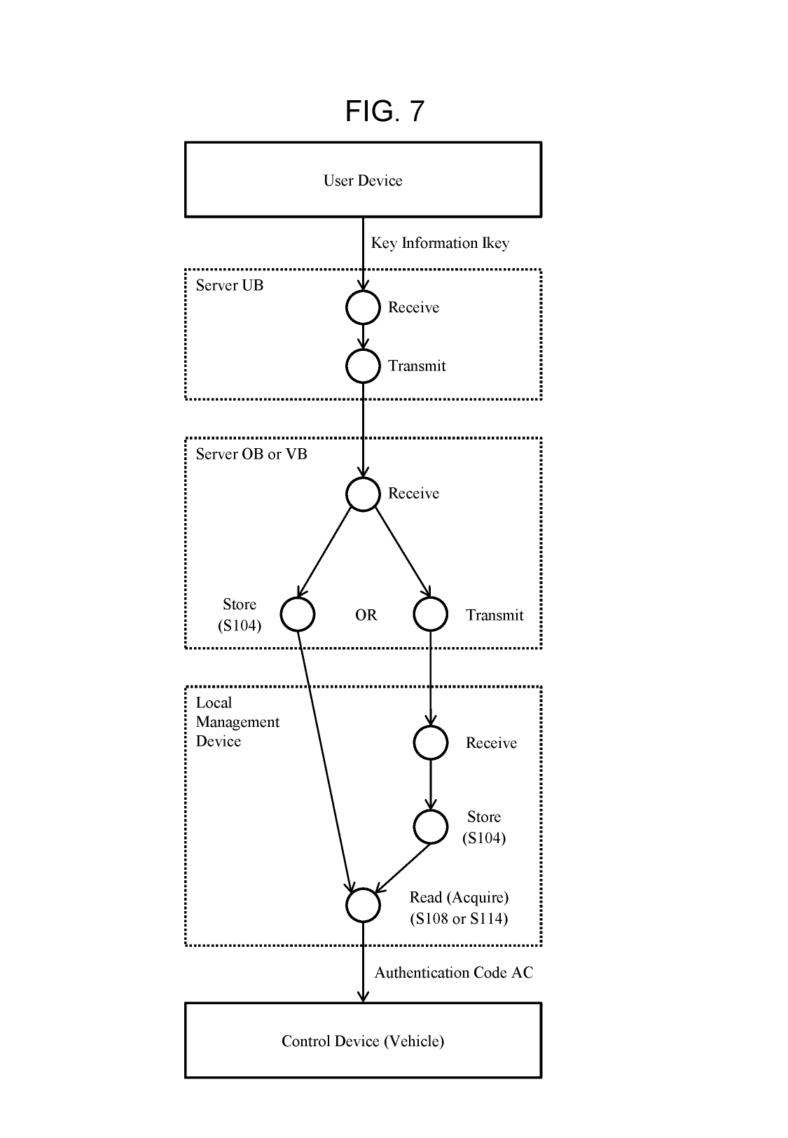

FIG. 7 is a diagram showing a first example of the acquisition path and storage destination of the key information Ikey. In the first example, the user device 30 transmits the key information Ikey to the management server 12 (more specifically, the server UB) using a wireless communication (e.g., LTE) in conjunction with the handover start request. The server UB receives the key information Ikey from the user device 30 and transmits the received key information Ikey to the server OB or VB.

The server OB or VB receives the key information Ikey from the server UB. Then, the server OB or VB may store the received key information Ikey in the memory device 123 thereof (step S104). Alternatively, the server OB or VB may transmit the received key information Ikey to the local management device 11. When the key information Ikey is transmitted from the server OB or VB to the local management device 11 in this manner, the local management device 11 stores the acquired (received) key information Ikey in the memory device 113 of the local management device 11 (step S104).

When transmitting the authentication code AC together with the start-up request of the travel system 23 to the vehicle 1 (step S108 or S114), the local management device 11 reads and acquires the key information Ikey from the memory device 123 or 113. Then, the local management device 11 transmits the authentication code AC included in the acquired key information Ikey to the control device 21 (vehicle 1).

As described above, in the first example, the local management device 11 acquires the key information Ikey from the user device 30 via the management server 12.

### 3-1-2-2. Second Example

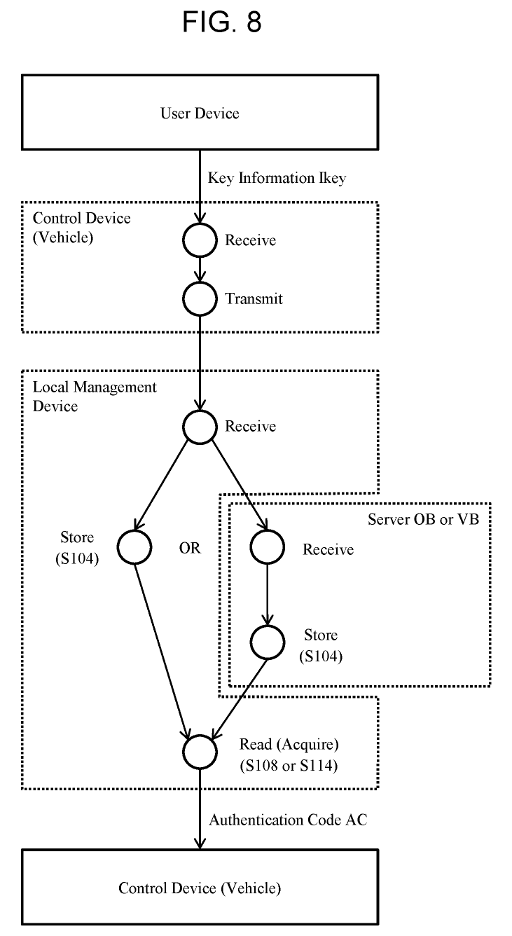

FIG. 8 is a diagram showing a second example of the acquisition path and storage destination of the key information Ikey. In the second example, the user device 30 transmits the key information Ikey to the control device 21 (vehicle 1) using a wireless communication (e.g., Wi-Fi) in conjunction with the handover start request. The control device 21 receives the key information Ikey from the user device 30 and transmits the received key information Ikey to the local management device 11 using a wireless communication (e.g., Wi-Fi).

The local management device 11 receives the key information Ikey from the control device 21. Then, the local management device 11 may store the received key information Ikey in the memory device 113 of the local management device 11 (step S104). Alternatively, the local management device 11 may transmit the received key information Ikey to the server OB or to the server VB (via the servers OB and UB). When the key information Ikey is transmitted from the local management device 11 to the server OB or VB in this manner, the server OB or VB stores the acquired (received) key information Ikey in the memory device 123 thereof (step S104).

Also in the second example, when transmitting the authentication code AC together with the start-up request of the travel system 23 to the vehicle 1 (step S108 or S114), the local management device 11 reads and acquires the key information Ikey from the memory device 123 or 113. Then, the local management device 11 transmits the authentication code AC included in the acquired key information Ikey to the control device 21 (vehicle 1).

As described above, in the second example, the local management device 11 acquires the key information Ikey from the user device 30 via the control device 21 (vehicle 1).

### 3-1-2-3. Third Example

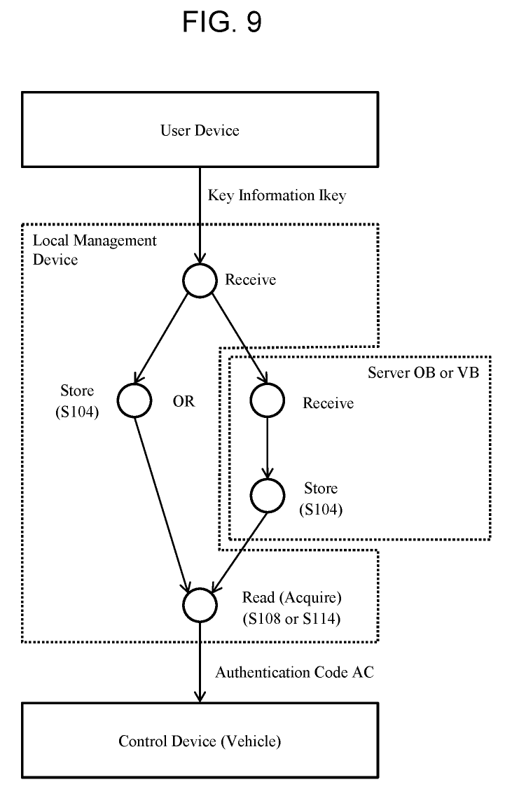

FIG. 9 is a diagram showing a third example of the acquisition path and storage destination of the key information Ikey. In the third example, the user device 30 transmits the key information Ikey directly to the local management device 11 using a wireless communication (e.g., Wi-Fi) or a wireless communication of the same type as the communication Ckey, in conjunction with the handover start request. As shown in FIG. 9, the processing after the local management device 11 receives the key information Ikey from the user device 30 is the same as the processing according to the second example shown in FIG. 8.

Also in the third example, when transmitting the authentication code AC together with the start-up request of the travel system 23 to the vehicle 1 (step S108 or S114), the local management device 11 reads and acquires the key information Ikey from the memory device 123 or 113. Then, the local management device 11 transmits the authentication code AC included in the acquired key information Ikey to the control device 21 (vehicle 1).

As described above, in the third example, the local management device 11 acquires the key information Ikey directly from the user device 30.

Additionally, as in the first to third examples described above, the key information Ikey may be stored in any of the memory device 113 of the local management device 11, the memory device 123 of the server OB, and the memory device 123 of the server VB. Furthermore, in an example in which the manufacturer of the vehicle 1 manages the server VB, it is desirable to store the key information Ikey transmitted from the user device 30 in the memory device 123 of the server VB, and have the local management device 11 (not managed by the manufacturer) read and use the key information Ikey from the memory device 123 only when the key information Ikey is used, in order to ensure high security of the vehicle 1.

### 3-2. Effect

As described above, according to the present embodiment, when starting up the travel system 23 of the vehicle 1, the vehicle management system 10 transmits "the authentication code AC included in the key information Ikey acquired from the user device 30 when the handover start request is given" to the control device 21 of the vehicle 1 together with the start-up request of the travel system 23, and causes the control device 21 to remove the prohibition on the start-up of the travel system 23 by the immobilizer. This allows the vehicle management system 10 to start up the travel system 23 without the need for the user X to wait near the vehicle 1 until the vehicle management system 10 starts up the travel system 23 after the handover processing is completed. This leads to improving convenience for the user X in an automated driving service (e.g., AVP service) in a predetermined area.

Additionally, as described above, the management system 10 acquires the key information Ikey when the handover start request is given. In other words, according to the present embodiment, the management system 10 does not need to acquire the key information Ikey in advance prior to starting the AVP service, and consideration is given to minimizing the period during which the management system 10 holds the key information Ikey. This contributes to improving convenience for the user X while ensuring high security of the vehicle 1 regarding the start-up of the travel system 23.

Moreover, as described above in Section 3-1-1-1, the management system 10 may delete the key information Ikey from the memory device 123 or 113 upon the end of the handover period during which the operating authority of the vehicle 1 is transferred to the management system 10. This makes it possible to appropriately limit the period during which the management system 10 holds the key information Ikey in consideration of the security of the vehicle 1 while enabling the start-up of the travel system 23 in response to the start-up request from the management system 10 when the vehicle 1 enters and leaves the predetermined area.

Furthermore, as described above in Section 3-1-1-2, the management system 10 may delete the key information Ikey from the memory device 123 or 113 upon the arrival of the vehicle 1 at the pick-up area 4 in order to leave the predetermined area (e.g., parking lot 2). This makes it possible to more appropriately limit the period during which the management system 10 holds the key information Ikey so as to further enhance the security of the vehicle 1 while enabling the start-up of the travel system 23 in response to the start-up request from the management system 10 when the vehicle 1 enters and leaves the predetermined area. In addition, in a situation where it takes time for the user X to move to the vehicle 1 after the vehicle 1 arrives at the pick-up area 4, which delays the execution of the handback processing, the deletion of the key information Ikey upon arrival of the vehicle 1 at the pick-up area 4 as described above contributes to the user X's sense of security.

What is claimed is:

1. A vehicle management system for managing a vehicle in a predetermined area, the vehicle management system comprising:
one or more memory devices; and
processing circuitry configured to:
in response to a handover start request from a user device that stores key information for causing the user device to function as a digital key of the vehicle, start handover processing for transferring operating authority of the vehicle from a user to the vehicle management system;
when the handover start request is given, acquire the key information from the user device and store the key information in the one or more memory devices, wherein the key information includes an authentication code for removing a prohibition on a start-up of a travel system of the vehicle by an immobilizer of the vehicle; and
when starting up the travel system, transmit to a control device of the vehicle, the authentication code together with a start-up request of the travel system and cause the control device to remove the prohibition on the start-up.

2. The vehicle management system according to claim 1, wherein
the processing circuitry is further configured to delete the key information from the one or more memory devices upon an end of a handover period during which the operating authority is transferred to the vehicle management system.

3. The vehicle management system according to claim 1, wherein
the processing circuitry is further configured to delete the key information from the one or more memory devices upon an arrival of the vehicle at a pick-up area in order to leave the predetermined area.

4. The vehicle management system according to claim 1, wherein
the vehicle management system includes a local management device installed in the predetermined area,
the processing circuitry includes first processing circuitry included in the local management device, and
when starting up the travel system, the first processing circuitry transmits to the control device, the authentication code together with the start-up request of the travel system and causes the control device to remove the prohibition on the start-up.

5. The vehicle management system according to claim 4, wherein
the vehicle management system includes one or more management servers on a cloud that are configured to communicate with the local management device, and
the local management device acquires the key information from the user device via the one or more management servers.

6. The vehicle management system according to claim 4, wherein
the local management device acquires the key information from the user device via the control device.

7. The vehicle management system according to claim 4, wherein
the local management device acquires the key information directly from the user device.

8. The vehicle management system according to claim 1, wherein
the predetermined area is a parking lot that supports an automated valet parking service, and
the processing circuitry starts up the travel system in the predetermined area when starting to move the vehicle from a drop-off area of the parking lot to a parking space allocated to the vehicle.

9. The vehicle management system according to claim 1, wherein
the predetermined area is a parking lot that supports an automated valet parking service, and
the processing circuitry starts up the travel system in the predetermined area when starting to move the vehicle from a parking space of the vehicle to a pick-up area of the parking lot.

10. A vehicle management method for managing a vehicle in a predetermined area, the vehicle management method, which is executed by a computer, comprising:
in response to a handover start request from a user device that stores key information for causing the user device to function as a digital key of the vehicle, starting handover processing for transferring operating authority of the vehicle from a user to a vehicle management system;
when the handover start request is given, acquiring the key information from the user device and storing the key information in one or more memory devices of the vehicle management system, wherein the key information includes an authentication code for removing a prohibition on a start-up of a travel system of the vehicle by an immobilizer of the vehicle; and
when starting up the travel system, transmitting to a control device of the vehicle, the authentication code together with a start-up request of the travel system and causing the control device to remove the prohibition on the start-up.

11. A non-transitory computer-readable recording medium storing a vehicle management program executed by a computer for managing a vehicle in a predetermined area,
the vehicle management program causing the computer to execute:
in response to a handover start request from a user device that stores key information for causing the user device to function as a digital key of the vehicle, starting handover processing for transferring operating authority of the vehicle from a user to a vehicle management system;
when the handover start request is given, acquiring the key information from the user device and storing the key information in one or more memory devices of the vehicle management system, wherein the key information includes an authentication code for removing a prohibition on a start-up of a travel system of the vehicle by an immobilizer of the vehicle; and
when starting up the travel system, transmitting to a control device of the vehicle, the authentication code together with a start-up request of the travel system and causing the control device to remove the prohibition on the start-up.
